(19) United States
(12) Patent Application Publication
(10) Pub. No.: US 2026/0170892 A1
(43) Pub. Date: Jun. 18, 2026

(54) VEHICLE LIFE CYCLE POWER MANAGEMENT MODES

(71) Applicant: Ford Global Technologies, LLC, Dearborn, MI (US)

(72) Inventors: Stuart C. Salter, White Lake, MI (US); Vincent John Boscheratto, Allen Park, MI (US); John Budaj, West Bloomfield, MI (US); Belal A. Ebah, Dearborn, MI (US); David Celinske, Wolverine Lake, MI (US); Chaitra Podali Mahesh, Haslet, TX (US); David Lloyd Nutt, Monroe, MI (US); Mark Roseman, Southfield, MI (US); Todd Ansbacher, Westland, MI (US); Timothy Thivierge, Jr., Carleton, MI (US)

(21) Appl. No.: 18/982,658

(22) Filed: Dec. 16, 2024

(51) Int. Cl. G07C 9/00; B60R 16/033

(52) U.S. Cl. CPC G07C 9/00309; B60R 16/033; G07C 2009/00365; G07C 2009/00587

(57) ABSTRACT

A plurality of life cycle power management modes are implemented for a vehicle. A vehicle is operated in a transport mode wherein controllers of the vehicle are configured to reduce their respective key-off loads on a battery of the vehicle, including that doors of the vehicle are unlocked and access control systems of the vehicle are unpowered. Responsive to receipt of a first request for moving the vehicle to a transport temporary normal mode, the vehicle transitions from the transport mode to the transport temporary normal mode which is another of the life cycle power management modes. In the transport temporary normal mode, the controllers of the vehicle are configured to operate in a full power state. After a predefined timeout period elapses after detecting a key-off state and/or closure of the doors of the vehicle, the vehicle returns from the transport temporary normal mode to the transport mode.

### TECHNICAL FIELD

Aspects of the disclosure generally relate to life cycle power management modes for a vehicle.

### BACKGROUND

Vehicle key-off load may be defined as a current drain on a battery of a vehicle when the ignition key is in the off position. In some cases, when a vehicle is parked for an extended period of time, key-off load may cause a significant reduction in the state of charge of the vehicle battery. Some drivers limit key-off load by electrically disconnecting the battery when leaving the vehicle parked for an extended time. However, for some vehicles the battery is difficult to access, and in any event such approaches are inconvenient for the driver.

### SUMMARY

In one or more illustrative examples, a method for implementing a plurality of life cycle power management modes for a vehicle includes operating a vehicle in a transport mode wherein controllers of the vehicle are configured to reduce their respective key-off loads on a battery of the vehicle while the vehicle is being transported, including that doors of the vehicle are unlocked and access control systems of the vehicle are unpowered; responsive to receipt of a first request for moving the vehicle to a transport temporary normal mode, transitioning the vehicle from the transport mode to the transport temporary normal mode, the transport temporary normal mode being another of the life cycle power management modes, wherein, in the transport temporary normal mode, the controllers of the vehicle are configured to operate in a full power state; and returning the vehicle from the transport temporary normal mode to the transport mode after a predefined timeout period elapses after detecting a key-off state and/or closure of the doors of the vehicle.

In one or more illustrative examples, the method further includes transitioning the vehicle from a factory mode to the transport mode responsive to the vehicle detecting that the vehicle has left a geofenced area of a factory, the factory mode being another of the plurality of the life cycle power management modes.

In one or more illustrative examples, the transport mode comprises a shallow sleep substate in which network hardware providing vehicle connectivity over a communications network is powered to receive over-the-air updates for a predefined period of time; and a deep sleep substate following the shallow sleep substate, in which the network hardware is unpowered to further reduce power consumption after the predefined period elapses.

In one or more illustrative examples, the method further includes responsive to receipt of a second request, the second request indicating for the vehicle to transition to a storage mode, transitioning the vehicle from the transport mode to the storage mode, the storage mode being another of the life cycle power management modes, wherein in the storage mode, the doors are locked and a near field communication (NFC) access control system of the vehicle is powered to allow controlled access to the vehicle.

In one or more illustrative examples, the second request includes the vehicle having entered a geofenced area of a dealership.

In one or more illustrative examples, the method further includes transitioning the vehicle from the transport mode to a normal mode responsive to detecting at least one of: the vehicle having driven a predefined distance threshold, receipt of an indication that a warranty of the vehicle is activated, and/or that the vehicle has remained outside the geofenced area of the dealership for at least a predefined time period.

In one or more illustrative examples, the method further includes responsive to detecting an NFC credential by the NFC access control system of the vehicle, transitioning the vehicle from the storage mode to a storage temporary normal mode, the storage temporary normal mode being another of the life cycle power management modes, wherein in the storage temporary normal mode the controllers of the vehicle are configured to operate in the full power state; and returning the vehicle from the storage temporary normal mode to the storage mode after the predefined timeout period elapses after detecting the key-off state and/or closure of the doors of the vehicle.

In one or more illustrative examples, the method further includes receiving a life cycle mode message from a life cycle service of a cloud server, the life cycle mode message indicating one or more of the first request or the second request; and responsive to performing the transitioning requested by the life cycle mode message, sending a life cycle update message to the life cycle service of the cloud server indicating that the transitioning was performed.

In one or more illustrative examples, the method further includes while in the storage mode and/or in the transport mode, sending remote status updates to the life cycle service indicating one or more of a current location of the vehicle and/or a state of charge of the battery of the vehicle.

In one or more illustrative examples, the method further includes announcing the transitioning between life cycle power management modes using a human-machine interface (HMI) of the vehicle.

In one or more illustrative examples, a vehicle implementing a plurality of life cycle power management modes includes a battery; and a plurality of controllers configured to operate a vehicle in a transport mode wherein controllers of the vehicle are configured to reduce their respective key-off loads on a battery of the vehicle while the vehicle is being transported, including that doors of the vehicle are unlocked and access control systems of the vehicle are unpowered; responsive to receipt of a first request for moving the vehicle to a transport temporary normal mode, transition the vehicle from the transport mode to the transport temporary normal mode, the transport temporary normal mode being another of the life cycle power management modes, wherein, in the transport temporary normal mode, the controllers of the vehicle are configured to operate in a full power state; and return the vehicle from the transport temporary normal mode to the transport mode after a predefined timeout period elapses after detecting a key-off state and/or closure of the doors of the vehicle.

In one or more illustrative examples, the plurality of controllers are further configured to transition the vehicle from a factory mode to the transport mode responsive to the vehicle detecting that the vehicle has left a geofenced area of a factory, the factory mode being another of the plurality of the life cycle power management modes.

In one or more illustrative examples, the transport mode comprises a shallow sleep substate in which network hardware providing vehicle connectivity over a communications network is powered to receive over-the-air updates for a predefined period of time; and a deep sleep substate following the shallow sleep substate, in which the network hardware is unpowered to further reduce power consumption after the predefined period elapses.

In one or more illustrative examples, the plurality of controllers are further configured to responsive to receipt of a second request, the second request indicating for the vehicle to transition to a storage mode, transition the vehicle from the transport mode to the storage mode, the storage mode being another of the life cycle power management modes, wherein in the storage mode, the doors are locked and a NFC access control system of the vehicle is powered to allow controlled access to the vehicle.

In one or more illustrative examples, the second request includes the vehicle having entered a geofenced area of a dealership.

In one or more illustrative examples, the plurality of controllers are further configured to transition the vehicle from the transport mode to a normal mode responsive to detecting at least one of: the vehicle having driven a predefined distance threshold, receipt of an indication that a warranty of the vehicle is activated, and/or that the vehicle has remained outside the geofenced area of the dealership for at least a predefined time period.

In one or more illustrative examples, the plurality of controllers are further configured to responsive to detecting an NFC credential by the NFC access control system of the vehicle, transition the vehicle from the storage mode to a storage temporary normal mode, the storage temporary normal mode being another of the life cycle power management modes, wherein in the storage temporary normal mode the plurality of controllers are configured to operate in the full power state; and return the vehicle from the storage temporary normal mode to the storage mode after the predefined timeout period elapses after detecting the key-off state and/or closure of the doors of the vehicle.

In one or more illustrative examples, the plurality of controllers are further configured to receive a life cycle mode message from a life cycle service of a cloud server, the life cycle mode message indicating one or more of the first request or the second request; and responsive to performing the transition requested by the life cycle mode message, send a life cycle update message to the life cycle service of the cloud server indicating that the transition was performed.

In one or more illustrative examples, the plurality of controllers are further configured to, while in the storage mode and/or in the transport mode, send remote status updates to the life cycle service indicating one or more of a current location of the vehicle and/or a state of charge of the battery of the vehicle.

In one or more illustrative examples, the plurality of controllers are further configured to announce the transition between life cycle power management modes using a HMI of the vehicle.

### BRIEF DESCRIPTION OF THE DRAWINGS

FIG. 1 illustrates an example vehicle for implementing a plurality of life cycle power management modes;

FIG. 2 illustrates an example life cycle power management system for the remote configuration of the life cycle power management modes;

FIG. 3 illustrates details of the life cycle power management modes that may be selectively applied to the vehicles;

FIG. 4 illustrates an example process for transitioning the vehicle between the transport mode, the transport temporary normal mode, and the normal mode;

FIG. 5 illustrates an example process for transitioning the vehicle by a dealer between the storage mode, the storage temporary normal mode, and the normal mode;

FIG. 6 illustrates an example process for transitioning the vehicle by an end customer between the storage mode and the normal mode;

FIG. 7 illustrates an example process for the remote configuration of the life cycle power management modes of one or more vehicles; and

FIG. 8 illustrates an example computing device for use in implementing a plurality of life cycle power management of vehicles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicles in production, transit, and on the dealer lot may be placed in a low power mode to prevent excessive key off load (KOL) and draining or damage to the battery. However, vehicles may be taken out of the transport mode and put into a normal mode to demo the vehicle. A result of this is that vehicles can be left on the dealer lot in the normal mode. This results in higher KOL. Over time, this load may drain the vehicle battery.

An improved power management system for a vehicle may define a plurality of power states and transitions between the modes. A vehicle may be configured into the different power modes based on the lifecycle of the vehicle, such as the vehicle being in transit, the vehicle being at a dealership, the vehicle being sold to a customer, etc. The different modes may affect the KOL due to the supported functions of the vehicle in each mode. These modes are referred to herein as life cycle power management modes.

For example, when a vehicle is being built, the vehicle may begin in a factory mode where vehicle components are configured for the factory environment. This may include allowing sensors and/or diagnostics to operate to ensure the correctness of the vehicle build, to identify the location of the vehicle, etc.

Once the vehicle is built, the vehicle may transition into a transport mode. In the transport mode, the vehicle components may be configured to perform operations to reduce their respective key-off loads on the vehicle. These operations may include, for example, to turn off power to all components except what is required to recognize a door open action. Responsive to occurrence of the door open action, the components may be powered up for a predefined time period after the door is shut (e.g., five minutes) before returning to the low power transport mode.

If the vehicle is in the transport mode on the dealer lot, it may be difficult for the sales staff to illustrate the functionality of the vehicle. Thus, the vehicle may transition to a dealer storage mode. In the dealer storage mode, entry is allowed only using near field communication (NFC) functionality, reducing the power requirements of the vehicle access functions but allowing the vehicle to remain locked.

When entry is observed to the vehicle from the dealer mode, the vehicle is temporarily returned to a full power mode where all components are active. This temporary normal mode may automatically return to the storage mode to prevent vehicles on the dealer lot accidentally being left in a full power mode. The customer may also manually select for the vehicle to be placed into the storage mode. This may allow the customer to place the vehicle into a low power state for extended parking (such as at the airport). However, in the customer case, a return to the vehicle automatically returns the vehicle to the normal power mode, instead of defaulting to remaining in the storage mode.

In some examples, a remote life cycle change tool may be provided that allows a fleet owner or other vehicle operator to remotely transition vehicles into the various modes. The tool may also allow for geofence or other criteria to be set to configure automatic power state changes for the vehicle. Further aspects of the life cycle power management modes are discussed in detail herein.

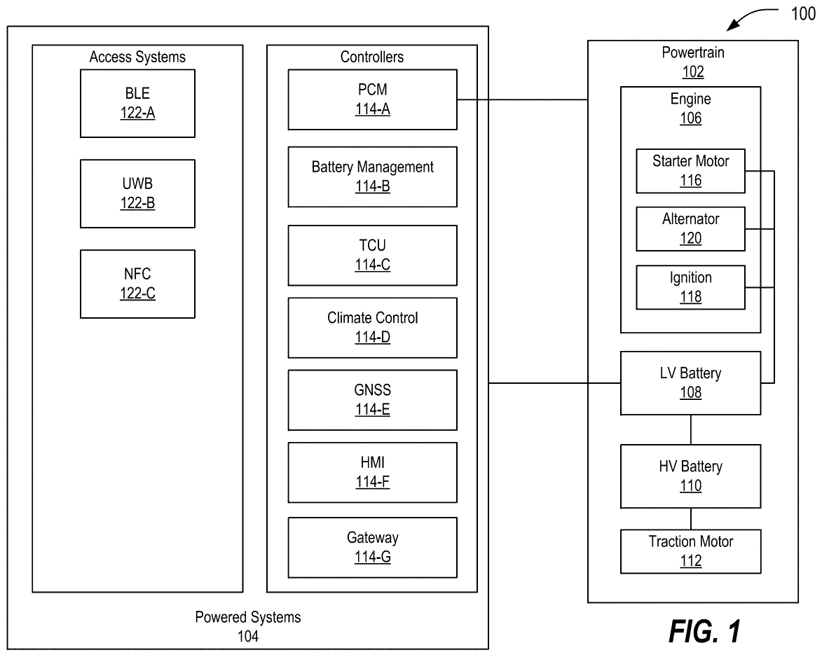

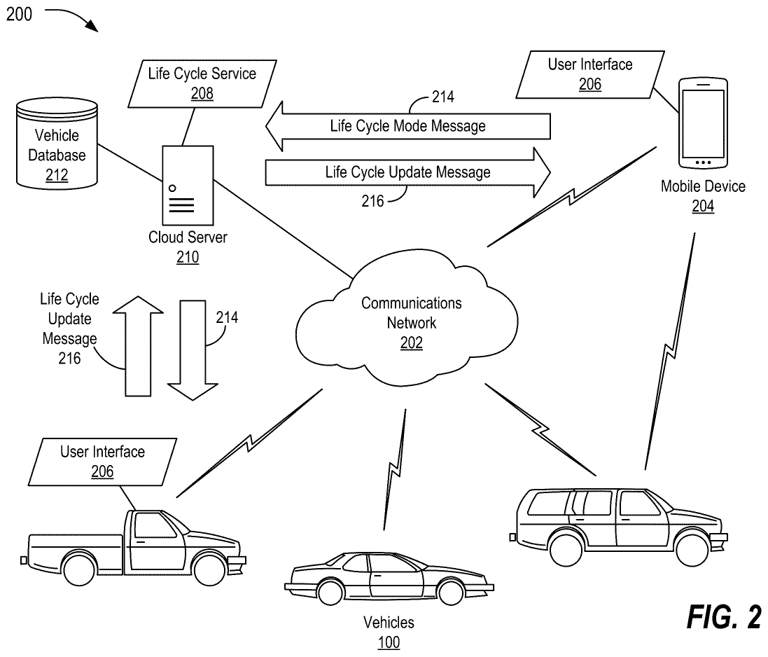

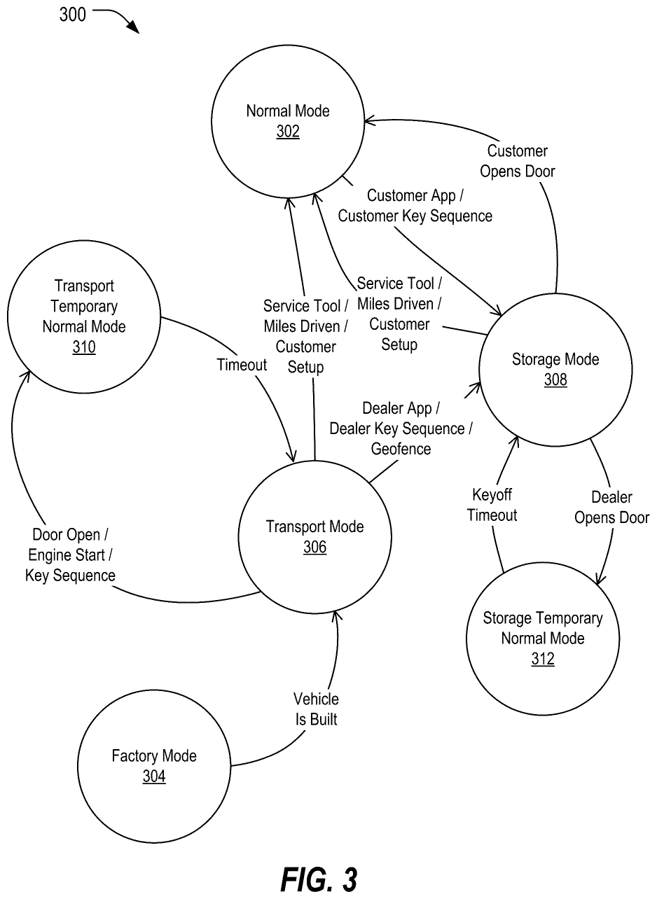

FIG. 1 illustrates an example vehicle 100 for implementing a plurality of life cycle power management modes 300. FIG. 2 illustrates an example life cycle system 200 including the vehicle 100 for the remote configuration of the life cycle power management modes 300. FIG. 3 illustrates details of the life cycle power management modes 300 that may be selectively applied to the vehicles 100.

With reference to FIG. 1, the vehicle 100 includes a powertrain 102 configured to power a plurality of powered system 104. These powered systems 104 may including various controllers 114 implementing functions of the vehicle 100 as well as access control systems 122 selectively providing access to the vehicle 100. Which functions of the controllers 114 are powered and which functions are unpowered depends on the life cycle power management mode 300 in which the vehicle 100 is operating.

The powertrain 102 may include one or more of an engine 106, a low-voltage (LV) battery 108, a high-voltage (HV) battery 110, and a traction motor 112. The LV battery 108 may include various types of rechargeable battery configured to supply electric energy to various components of the vehicle 100. In an example, the LV battery 108 may be a 12 Volt lead-acid battery. The LV battery 108 may be configured to power a starter motor 116 and an ignition system 118 of the engine 106 when the engine 106 is not running, and may receive electric charge from an alternator 120 when the engine 106 is running. The HV battery 110 may include a traction battery or battery pack configured to store energy that can be used by one or more traction motors 112 of the vehicle 100 that provide propulsion and deceleration capability, whether the engine 106 is turned on or off.

The powered systems 104 may include controller 114 configured to perform various functions under the power of the powertrain 102, including under the power of the LV battery 108 and/or HV battery 110. The controllers 114 may include various types of computing apparatus to facilitate the performance of their functions. As depicted, the controllers 114 are represented as discrete controller 114. However, the controller 114 may share physical hardware, firmware, and/or software, such that the functionality from multiple controllers 114 may be integrated into a single controller 114, and that the functionality of various such controllers 114 may be distributed across a plurality of controllers 114.

As some non-limiting controller 114 examples, a powertrain control module 114-A may be configured to provide control of engine 106 operating components (e.g., idle control components, fuel delivery components, emissions control components, etc.) and for monitoring status of such engine operating components (e.g., status of engine fault codes); a battery management controller 114-B may be configured to compute and provide state of charge status (e.g., to the powertrain control module 114-A or others); a telematics control unit (TCU) 114-C may be configured to send and receive commands from the paired communications device or wireless network connection using the facilities a radio transceiver (e.g., to provide low battery alerts to a driver's phone or to a web database); a climate control management controller 114-D may be configured to provide control of heating and cooling system components (e.g., compressor clutch, blower fan, temperature sensors, etc.); a global navigation satellite system (GNSS) controller 114-E may be configured to provide location services for the vehicle 100; a human-machine interface (HMI) controller 114-F may be configured to provide status information about the vehicle 100 to a driver, such as fuel level info, engine operating temperature information, and current location of the vehicle 100, and a gateway controller 114-G may be configured to route messages between the other controllers 114 across various vehicle buses. As some non-limiting examples, the buses of the vehicle 100 may include controller area network (CAN) buses and/or Ethernet networks.

The powered systems 104 may also include various access control systems 122 facilitating access to the cabin or other components of the vehicle 100. These access control systems 122 may include one or more of a Bluetooth Low Energy (BLE) access control system 122-A, an ultra-wideband (UWB) access control system 122-B, and/or a NFC access control system 122-C.

The BLE access control system 122-A may include hardware to allow for the vehicle 100 to be unlocked using Bluetooth low energy devices. For example, the vehicle 100 may include an array of antennas configured to facilitate communication between a mobile device and the vehicle 100. For instance, a plurality of antennas may be placed about the vehicle 100 to form a BLE array that may be used to triangulate or otherwise detect the location of the mobile UWB transceiver of the mobile device. The BLE transceivers may be controlled by a BLE controller of the BLE access control system 122-A, which may include a memory and a processor programmed to send and receive messaging between the mobile device and the vehicle 100 (e.g., to provide for the performance of challenge-response sequences and/or to receive commands from the vehicle 100).

The UWB access control system 122-B may include hardware to allow for the vehicle 100 to be unlocked using an UWB device. For example, the vehicle 100 may be configured to utilize the BLE antennas (or different antennas) to send and receive messaging between a mobile UWB transceiver of a mobile device and the vehicle 100. As compared to BLE, UWB can provide for more precise location determination. For instance, UWB can measure distance and location to an accuracy of on the order of 5 to 10 cm, while BLE typically reaches an accuracy on the order of meters.

The NFC access control system 122-C may include hardware to allow for the vehicle 100 to be unlocked using an NFC card or other NFC device. The NFC access control system 122-C may include, for example, a driver door NFC card reader and a driver door module in communication with the card reader and configured to power the NFC card reader. If a valid NFC card is presented, the NFC card reader may direct the vehicle 100 to unlock.

FIG. 2 illustrates an example life cycle system 200 including a life cycle service 208 in communication with a mobile device 204 and the vehicle 100 implementing a plurality of life cycle power management modes 300. A communications network 202 may include one or more interconnected communication networks configured to provide communications services, such as Internet access, voice or data over Internet Protocol (IP) communications, short messaging service (SMS) and/or multimedia messaging service (MMS) communications, and location services, to at least one connected device. As some examples, the communications network 202 may include the Internet, a satellite link network, a wireless wide area network, and a cellular telephone network, as some non-limiting possibilities.

The mobile devices 204 may include various computing devices configured to communicate over the communications network 202 as well as to move in location with respect to the physical structure of the communications network 202. Exemplary mobile devices 204 may include laptop computers, mobile telephones and smartphones, GNSS devices, tablet computers, and the vehicles 100 themselves that include built-in modems.

The mobile devices 204 may be configured to provide a user interface 206. Additionally or alternately, the vehicles 100 may be configured to provide a user interface 206 within the vehicle 100 e.g., using the services of the HMI controller 114-F of the vehicle 100.

The life cycle service 208 may be an application executed by the hardware of a cloud server 210. The cloud server 210 may include one or more computing devices configured for communication with devices connected to the communications network 202. The cloud server 210 may also be configured to access a database 212. The database 212 may be configured to maintain information about the vehicles 100. This information may include one or more of the current life cycle power management modes 300 of the vehicles 100, vehicle identification numbers (VINs) of the vehicles 100, and/or assignments of the vehicles 100 to fleets, accounts, and/or mobile devices 204.

FIG. 3 illustrates an example state diagram of different life cycle power management modes 300 of the vehicle 100. As shown, the life cycle power management modes 300 include a factory mode 304, a normal mode 302, a transport mode 306, a storage mode 308, a transport temporary normal mode 310, and a storage temporary normal mode 312. Each of these modes of the life cycle power management mode 300 is discussed in turn.

In the normal mode 302, the controllers 114 may be configured to implement an assortment of features for the customer. These include performing various functions of the vehicle 100 when the vehicle 100 is in drive or another configuration in which the vehicle 100 travels under its own power. The controllers 114 may be configured to perform at least a subset of their functions even when the vehicle 100 is parked and the engine 106 is not running and/or the traction motors 112 are unpowered (sometimes referred to herein as keyed-off).

As some non-limiting examples of functionality of the controllers 114 that may be performed in the normal mode 302 when the vehicle 100 is keyed off, the access control systems 122 may perform periodic polling for keyless entry, passive entry, or other access management features, the battery management controller 114-B may perform battery drive conditioning and warn regarding scheduled charges that are not occurring, the TCU 114-C may receive commands such as unlock or remote start, the climate control management controller 114-D may perform cabin preconditioning in anticipation of an expected trip by the driver at a time prescheduled with the vehicle 100, and the GNSS controller 114-E may provide location updates for the vehicle 100.

Functions performed by the controllers 114 in the normal mode 302 when the vehicle 100 is keyed off produce a current drain on the LV battery 108 of the vehicle 100. In some cases, when the vehicle 100 is parked for an extended period of time, the key-off loads due to the rich functionality in the normal mode 302 may cause a significant reduction in the state of charge of the LV battery 108.

To address these key-off loads, the vehicle 100 may be configured to operation in various additional life cycle power management modes 300 in which the key-off load of the vehicle 100 is reduced, with the tradeoff of limiting the functionality of the vehicle 100 is reduced in those life cycle power management modes 300.

For example, the vehicle 100 may begin its life cycle in the factory mode 304 as the vehicle 100 is being assembled. In the factory mode 304, the controllers 114 of the vehicle 100 are configured for the factory environment. This may include allowing sensors and/or diagnostics to operate to ensure the correctness of the vehicle 100 build, to identify the location of the vehicle 100 in the factory, and so on.

In the transport mode 306, the controller 114 of the vehicle 100 are configured to perform operations to reduce their respective key-off loads on the vehicle 100. This may be done, for example, to allow the LV battery 108 to be discharged as little as possible while the vehicle 100 is being transported to the dealer lot.

The vehicle 100 may transition from the factory mode 304 to the transport mode 306 based on various conditions. For example, the vehicle 100 may be expressly set into the transport mode 306 at the conclusion of the build of the vehicle 100. In another example, the vehicle 100 may detect leaving a geofenced area of a factory, such that once the vehicle 100 leaves the vehicle 100 transitions into the transport mode 306. In yet another example, the vehicle 100 may transition into the transport mode 306 after a period of time has elapsed since the vehicle 100 has been assembled and/or the controllers 114 being first introduced to power via a LV battery 108.

During transport, the vehicles 100 may be shipped with the doors unlocked and with the keys in the vehicles 100. This facilitates personnel getting into and moving the vehicles 100 as necessary for shipment. Accordingly, the access control systems 122 of the vehicle 100 that allow for locking and unlocking of the doors are not required to be powered. Thus, the access control system 122 functionality may be powered off in the transport mode 306. For example, the vehicle 100 may choose not to power the BLE access control system 122-A, the UWB access control system 122-B, or the NFC access control system 122-C. Yet, the vehicle 100 may continue to monitor for opening of vehicle 100 doors, which may be done with a switch that does not require key-off power to run.

In some examples, the transport mode 306 may define two sub-states: a shallow sleep initial substate and a deep sleep low-lower substate. In the shallow substate, some controllers 114 may remain powered for a predefined period of time (e.g., 14 days). This may allow the newly-build vehicle 100 to capture any pending over-the-air (OTA) updates, e.g., using a modem of the TCU 114-C or another internal modem of the vehicle 100. In the deep low-lower substate, the controllers 114 required for OTA update are also unpowered.

Responsive to the vehicle 100 detecting actions intending for the vehicle 100 to be used, the vehicle 100 may transition to the transport temporary normal mode 310. These trigger conditions may include, for example, the opening of a door while in the transport mode 306, and/or the user stating the engine 106 while in transport mode 306. In the transport temporary normal mode 310, the vehicle 100 may power the controllers 114 similar to as done in the normal mode 302. This may allow the vehicle 100 to be operate and move during transport of the vehicle 100 from the factory to a dealership or other destination for sale. The vehicle 100 may return to the transport mode 306 after a timeout has elapsed after the vehicle 100 is returned to a key-off state (e.g., after ten minutes of being keyed off in the transport temporary normal mode 310).

The transport temporary normal mode 310 is a separate mode from the normal mode 302 to allow for the vehicle 100 to be moved from one location to another while still generally remaining in a transport state. The automatic return to the transport mode 306 defined by the transport temporary normal mode 310 is advantageous over requiring the vehicle 100 to transition to the normal mode 302, because the vehicle 100 may not be moved back into the transport mode 306 (e.g., after, driving the vehicle 100 onto a car carrier), resulting in the vehicle 100 incurring unnecessary key-off load.

In the storage mode 308, the vehicle 100 powers down the controllers 114 for long-term storage at dealer lots or customer locations. The storage mode 308 is intended to reduce power consumption, as compared to the normal mode 302, in order to extend the time that a vehicle 100 can remain parked without requiring a battery recharge.

The vehicle 100 may transition from the transport mode 306 to the storage mode 308 based on various conditions. For example, the vehicle 100 may be expressly set into the storage mode 308 by an owner or operator of the vehicle 100. In another example, the vehicle 100 may transition to the storage mode 308 responsive to the vehicle 100 detecting that the vehicle 100 is inside a geofenced area of a dealership or other sales area. The geofence detection may be initiated responsive to a door of the vehicle 100 being opened, for example, as the vehicle 100 in the transport mode 306 may otherwise not track GNSS location. In yet another example, the vehicle 100 may transition into the storage mode 308 after a period of time without movement has elapsed since the vehicle 100 has been moved in the transport mode 306.

In the storage mode 308, power reductions per be performed including one or more of: (i) for controllers 114 that perform periodic polling of input, to slow down or stop their polling, (ii) to disable periodic clock accuracy adjustments to allow the human-readable clock to drift, (iii) to turn off tire pressure monitoring system (TPMS) monitoring, (iv) to turn off door sensors for passive entry features (e.g., apart from NFC access to via the driver door), (v) to limit or prevent embedded modem functionality and telecommunication updates, (vi) to disable approach detection features, (vii) to disable fuel operated heater systems, (viii) to disable extended play mode, (ix) to disable illuminated entry/exit lighting, (x) to limit or eliminate battery saver duration control length of interior lighting, (xi) to disable powertrain wake on door ajar, (xii) to disable wake on oil minder, and (xiii) to disable providing GNSS location updates. For hybrid or pure electric vehicles, these operations may also include, for example, (i) to discontinue cabin preconditioning, (ii) to discontinue battery drive conditioning, and to (iii) disable scheduled-charge-not-occurring signals.

For e-latch vehicles 100 in the storage mode 308, a central control zone module (CCZM) and e-latch subsystems may remain powered to allow a user to exit the vehicle 100. In some examples, the vehicle 100 may optionally power a modem so that tire pressure of the vehicle 100 and/or location of the vehicle 100 can be transmitted to the life cycle service 208.

In the storage mode 308, the vehicles 100 are typically left in a locked state, as opposed to in the transport mode 306 where the vehicle 100 are typically left unlocked with the keys present. Thus, in contrast to the transport mode 306 which prioritizes operational convenience for the movement of attended vehicles 100, the storage mode 308 has a greater emphasis on vehicle 100 protection because the vehicles 100 may spend more time being unattended. This means that, as opposed to the transport mode 306, in the storage mode 308 the NFC access control system 122-C is enabled to allow the vehicle 100 to be locked until an NFC credential is presented to granted access.

Responsive to the dealer presenting the NFC card or other credential, the vehicle 100 transitions from the storage mode 308 to the storage temporary normal mode 312. In the storage temporary normal mode 312, the vehicle 100 may power the controllers 114 similar to as done in the normal mode 302. This may allow the vehicle 100 to be generally operative for a customer who may wish to operate the features of the vehicle 100 before purchase. The vehicle 100 may return to the storage mode 308 after a timeout has elapsed after the vehicle 100 doors are closed and the vehicle is returned to a key-off state (e.g., after ten minutes of being keyed off in the storage temporary normal mode 312).

The storage temporary normal mode 312 is a separate mode from the normal mode 302 to allow for the vehicle 100 to be operated temporarily for demonstrations while still generally remaining in a storage state. The automatic return to the storage mode 308 defined by the storage temporary normal mode 312 is advantageous over requiring the vehicle 100 to transition to the normal mode 302 for demonstration, because the vehicle 100 may not be moved back into the storage mode 308 (e.g., after the customer leaves), resulting in the vehicle 100 incurring unnecessary key-off load.

When the vehicle 100 is sold, the vehicle 100 may transition from the storage mode 308 to the normal mode 302 due to the customer performing customer actions to the vehicle 100. In an example, NFC key presentation by the customer may cause the vehicle 100 to transition to the normal mode 302. For instance, the customer may use an NFC card (or equivalent) keyed to the vehicle 100 for customer access to enter the vehicle 100. Responsive to this action, the vehicle 100 may understand that the vehicle 100 has been sold and may transition into the normal mode 302. In another example, responsive to the customer setup actions being performed to the vehicle 100, such as the creation of seat, media, and/or navigation preferences, the vehicle 100 may understand that the vehicle 100 is to transition into the normal mode 302. In yet another example, an explicit key or other information may be entered into the vehicle 100 to inform the vehicle 100 to transition to the normal mode 302. In still another example, a cloud confirmation may be received to the vehicle 100 from the life cycle service 208 to cause the vehicle 100 to transition to the normal mode 302.

In some examples, the vehicle 100 may infer that a change in state from the transport mode 306 or the storage mode 308 to the normal mode 302 is necessary. For example due if the vehicle 100 is parked away from the dealer lot for an extended period (e.g., multiple nights), the vehicle 100 may automatically assume it has been sold and switch to the normal mode 302. As another example, when the vehicle 100 is started, the vehicle 100 may communicate with the life cycle service 208 to check the warranty activation date. If the vehicle 100 detects that the warranty has started, the vehicle 100 may shift to the normal mode 302.

As some other examples, if the vehicle 100 detects that a predefined number of miles have been driven by the vehicle 100, the vehicle 100 may automatically transition to the normal mode 302. In yet another example, a service tool may be connected to the vehicle 100 and used to set vehicle 100 into the normal mode 302.

In some examples, the user may utilize the user interface 206 to configure the life cycle power management mode 300 of the vehicles 100. As one possibility, the mobile device 204 may log into the life cycle service 208, such as via a web browser of the mobile device 204 connected to a web interface of the life cycle service 208 or by way of a client application of the mobile device 204 configured to communicate with life cycle service 208.

Responsive to the user making a selection from the user interface 206 of the vehicle 100, the vehicle 100 may be configured to receive the user input and adjust the life cycle power management mode 300 appropriately.

When the user makes a selection from the user interface 206 of the mobile device 204, the mobile device 204 may be configured to generate and send a life cycle mode message 214 to the life cycle service 208 over the communications network 202. The life cycle mode message 214 may include information indicating which of the life cycle power management modes 300 to place the vehicle 100 into. The life cycle mode message 214 may also include, for example, an identifier of the mobile device 204 making the request, an identifier of an account of a user of the mobile device 204 making the request (e.g., phone number, e-mail address, etc.), and/or an identifier of the vehicle 100 whose extended park mode setting is to be updated (e.g., VIN or some other unique vehicle 100 identifier). As another example, the life cycle service 208 may identify the vehicle 100 based on the information of the login session of the mobile device 204 with the life cycle service 208 (e.g., web session information, client application session state, etc.).

The life cycle service 208 may be configured to receive life cycle mode messages 214 over the communications network 202 from the mobile device 204, determine to which vehicle 100 the life cycle mode message 214 should be directed, and forward the life cycle mode message 214 to the appropriate vehicle 100.

When the vehicles 100 transition into and out of extended park mode, the vehicles 100 may be configured to provide life cycle update messages 216 to the life cycle service 208. The life cycle update messages 216 may include information such as the current life cycle power management mode 300 of the vehicle 100, an identifier of an account of a user associated with the vehicle 100 (e.g., phone number, e-mail address, etc.), and/or an identifier of the vehicle 100 whose extended park mode setting is updated (e.g., VIN or some other unique vehicle 100 identifier). These life cycle update messages 216 may accordingly allow the life cycle service 208 to track which vehicles 100 are in which of the life cycle power management mode 300.

In another example, the vehicle 100 may send life cycle update messages 216 including other information, such as the location of the vehicle 100, a request to confirm that the vehicle 100 may be started, a warning that the SoC of the LV battery 108 is below a predefined threshold, etc.

The vehicles 100 may also, in some examples, periodically wake to report their location to the life cycle service 208 to support a stolen vehicle service. The vehicle 100 may also, in some examples, wake to send a report if the SoC of the LV battery 108 is determined to be below a minimum threshold.

The vehicles 100 may also, in some examples, contact the life cycle service 208 to determine if a move is authorized before allowing the vehicle 100 to transition into a motive mode. This may be done, for example, if the vehicle 100 is in a transport temporary normal mode 310 and/or in a storage temporary normal mode 312 from a dealer-entered storage mode 308.

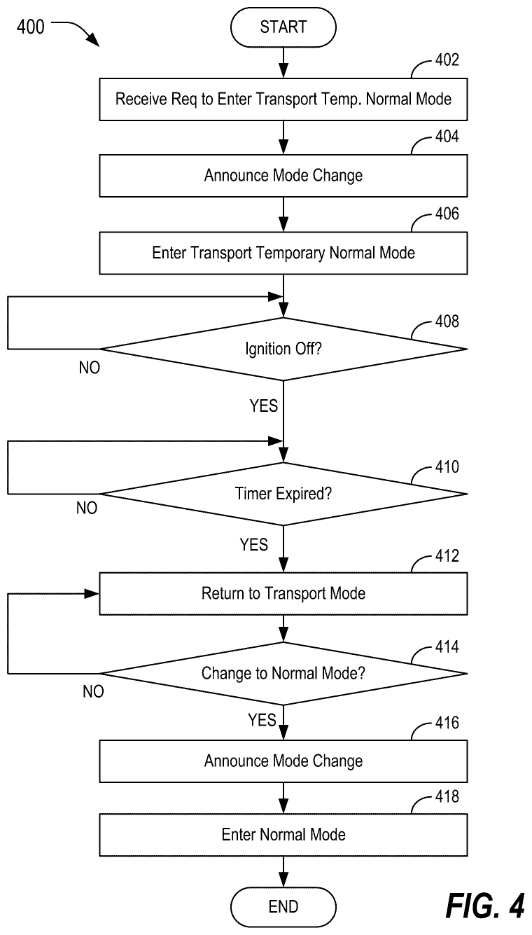

FIG. 4 illustrates an example process 400 for transitioning the vehicle 100 between the transport mode 306, the transport temporary normal mode 310, and the normal mode 302. In an example, the process 400 may be performed by the vehicle 100 in the context of the life cycle system 200 with reference to the life cycle power management modes 300. The process 400 begins with the vehicle 100 in the transport mode 306, which, as shown in FIG. 3, may be a result of the vehicle 100 leaving the factory mode 304.

At operation 402, the vehicle 100 receives a request to enter the transport temporary normal mode 310. In an example, the vehicle 100 may receive, via its user interface 206, a key sequence to cause the vehicle 100 to enter the transport temporary normal mode 310. In another example, the vehicle 100 may be started, which also may cause the vehicle 100 to enter the transport temporary normal mode 310. In yet another example, the vehicle 100 may receive a life cycle mode message 214 from the life cycle service 208 requesting that the vehicle 100 move to the transport temporary normal mode 310.

At operation 404, the vehicle 100 announces a mode change from the transport mode 306 to the transport temporary normal mode 310. In an example, the vehicle 100 may send a life cycle update message 216 to the life cycle service 208 indicating the change in life cycle power management mode 300. In another example, a message is displayed on the user interface 206 of the vehicle 100 and/or announced via an audio system of the vehicle 100 to inform the operator of the vehicle 100 of the change in life cycle power management mode 300.

At operation 406, the vehicle 100 enables features of the controllers 114 to implement the transport temporary normal mode 310. In this mode, the vehicle 100 operates consistent with the normal mode 302, re-enabling features that are disabled in the transport mode 306.

At operation 408, the vehicle 100 polls for the vehicle 100 to be keyed off. For example, the vehicle 100 may remain in the transport temporary normal mode 310 so long as the vehicle 100 is on and/or so long as the operator remains inside the vehicle 100 cabin. If the vehicle 100 is keyed off, control proceeds to operation 410. If not, control remains at operation 408 in the transport temporary normal mode 310.

At operation 410, the vehicle 100 determined whether a key-off timer has expired. In an example, the vehicle 100 may stay in the transport temporary normal mode 310 for a predefined time period after the key off. This period may be, for example, five minutes, ten minutes, etc. This period may allow for cases where the user leaves the vehicle 100 but then returns again to continue interaction in the transport temporary normal mode 310. After expiration of the time period, control proceed to operation 412.

At operation 412, the vehicle 100 returns to the transport mode 306. Accordingly, the access control system 122 functionality and/or other optional vehicle 100 functions may again be powered off in the transport mode 306.

At operation 414, the vehicle 100 determines whether the vehicle 100 should change to the normal mode 302. It should be noted that operation 414 may occur at any time that the vehicle 100 is in the transport mode 306, not only after a transition returning to the transport mode 306. The determination whether to change into the normal mode 302 may consider one or more factors. For example, if the vehicle 100 is parked away from the dealer lot for an extended period (e.g., multiple nights), the vehicle 100 may automatically assume it has been sold and should switch to the normal mode 302. As another example, when the vehicle 100 is started, the vehicle 100 may communicate with the life cycle service 208 to check the warranty activation date. If the vehicle 100 detects that the warranty has started, the vehicle 100 may determine to shift to the normal mode 302. As some other examples, if the vehicle 100 detects that a predefined number of miles have been driven by the vehicle 100, the vehicle 100 may determine to transition to the normal mode 302. In yet another example, a service tool may be connected to the vehicle 100 and used to set vehicle 100 into the normal mode 302. In still another example, the vehicle 100 may be expressly requested to move to the normal mode 302, via a user interface 206 of the mobile device 204 and life cycle mode message 214 from the life cycle service 208, and or via the user interface 206 of the vehicle 100. Responsive to occurrence of one or more of these conditions, control proceeds to operation 416. If not, control remains in the transport mode 306.

At operation 416, the vehicle 100 announces a mode change from the transport mode 306 to the normal mode 302. In an example, the vehicle 100 a life cycle update message 216 is sent to the life cycle service 208 indicating the change in life cycle power management mode 300. In another example, a message is displayed on the user interface 206 of the vehicle 100 and/or announced via an audio system of the vehicle 100 to inform the operator of the vehicle 100 of the change in life cycle power management mode 300.

At operation 418, the vehicle 100 enters the normal mode 302. In this mode, the controllers 114 may be configured to implement an assortment of features for the customer. These features may include, for example, the operation of the access control system 122, including the BLE access control system 122-A, the UWB access control system 122-B, and/or the NFC access control system 122-C. After operation 418, the process 400 ends.

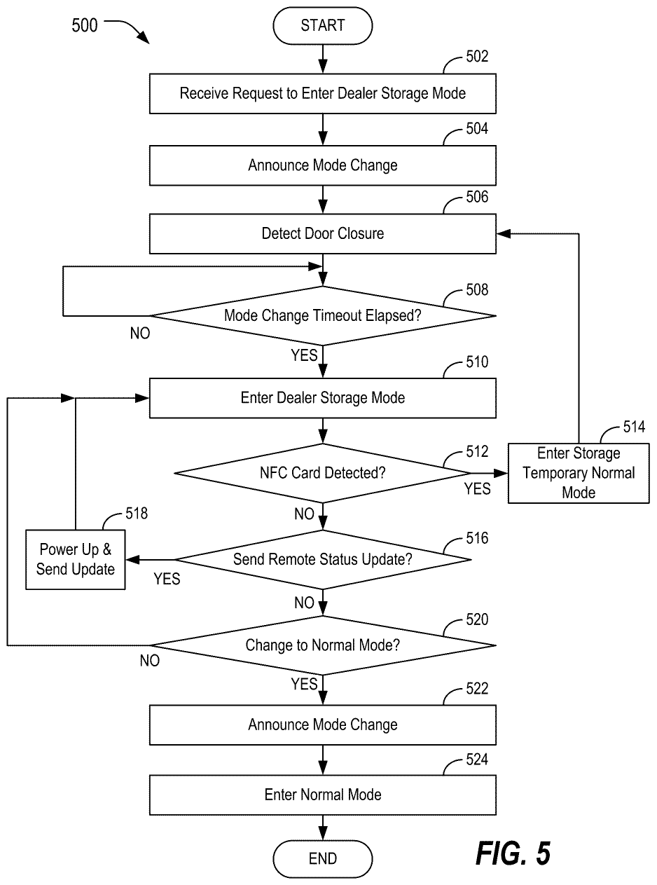

FIG. 5 illustrates an example process 500 for transitioning the vehicle 100 by a dealer between the storage mode 308, the storage temporary normal mode 312, and the normal mode 302. In an example, the process 500 may be performed by the vehicle 100 in the context of the life cycle system 200 with reference to the life cycle power management modes 300.

At operation 502, the vehicle 100 receives a request to enter the dealer storage mode 308. In an example, the vehicle 100 may receive, via its user interface 206, a key sequence to cause the vehicle 100 to enter the storage mode 308. In another example, the vehicle 100 may detect it is at a geofenced location of a dealership, which also may cause the vehicle 100 to enter the storage mode 308. In yet another example, the vehicle 100 may receive a life cycle mode message 214 from the life cycle service 208 requesting that the vehicle 100 move to the storage mode 308.

At operation 504, the vehicle 100 announces the change in mode from the transport mode 306 (or possibly from the normal mode 302) to the storage mode 308. In an example, the vehicle 100 may send a life cycle update message 216 to the life cycle service 208 indicating the change in life cycle power management mode 300. In another example, a message is displayed on the user interface 206 of the vehicle 100 and/or announced via an audio system of the vehicle 100 to inform the operator of the vehicle 100 of the change in life cycle power management mode 300.

At operation 506, the vehicle 100 detects closure of the door of the vehicle 100. In an example, the user may have utilized the user interface 206 of the vehicle 100 to move the vehicle 100 into the storage mode 308. In such an example, the vehicle 100 may wait for the user to exit the vehicle 100 in order to perform the change in mode. For instance, the vehicle 100 may monitor for the next closure of the driver door, as one possibility. It should be noted that, in cases where the vehicle 100 is requested to enter the storage mode 308 from outside the vehicle 100, such as via the mobile device 204, this door closure determination may not be performed.

At operation 508, the vehicle 100 determines whether a mode change timeout has elapsed. In an example, the vehicle 100 may defer the transition into the storage mode 308 for a predefined time period after the vehicle 100 is exited (or after the request to enter the dealer storage mode 308 if received remotely). This period may be, for example, five minutes, ten minutes, etc. After expiration of the time period, control proceed to operation 510.

At operation 510, the vehicle 100 enters the storage mode 308. In the storage mode 308, the vehicle 100 reduces power usage. This may include any of the various approaches discussed herein. Significantly, the vehicle 100 may turn off various access control systems 122, such as the BLE access control system 122-A and the UWB access control system 122-B but may allow the NFC access control system 122-C to remain powered to detect NFC credentials received to the vehicle 100, e.g., at the driver's side door NFC reader.

At operation 512, the vehicle 100 determines whether an NFC credential is detected. In an example, as at least a portion of the NFC access control system 122-C remains powered, the NFC access control system 122-C may indicate whether or not an NFC card or other credential is provided to the vehicle 100. If so, control proceeds to operation 514. If not, control proceeds to operation 516.

At operation 514, the vehicle 100 transitions to the storage temporary normal mode 312. In the storage temporary normal mode 312, the vehicle 100 may power the controllers 114 similar to as done in the normal mode 302. This may allow the vehicle 100 to be generally operative for a customer who may wish to operate the features of the vehicle 100 before purchase. After operation 514, control returns to operation 506. This allows the vehicle 100 to return to the storage mode 308 after the timeout has elapsed. Accordingly, the vehicle 100 may return to the storage mode 308 after the vehicle 100 doors are closed and the vehicle is returned to a key-off state and the timeout expires.

At operation 516, the vehicle 100 determines whether the vehicle 100 should wake to send a life cycle update message 216 to the life cycle service 208. For example, the vehicle 100 may send life cycle update messages 216 including other information, such as the location of the vehicle 100, a request to confirm that the vehicle 100 may be started, a warning that the SoC of the LV battery 108 is below a predefined threshold, etc. If the vehicle 100 determines to send one of these informative life cycle update messages 216, control proceeds to operation 518 to wake the vehicle 100 to allow for that life cycle update message 216 to be sent. After operation 518, control proceeds to operation 510 to re-enter the storage mode 308. If no such message is determined to be sent at operation 516, control proceeds to operation 520.

At operation 520, similar to operation 414 of the process 400, the vehicle 100 determines whether the vehicle 100 should change to the normal mode 302. It should be noted that operation 520 may occur at any time that the vehicle 100 is in the storage mode 308, not only after a transition returning to the transport mode 306. If the vehicle 100 should move to the normal mode 302 control proceeds to operation 522. Otherwise, control returns to operation 510 to remain in the storage mode 308.

At operation 522, as with operation 416, the vehicle 100 announces a mode change from the transport mode 306 to the normal mode 302. At operation 524, as with operation 418, the vehicle 100 enters the normal mode 302. After operation 524, the process 500 ends.

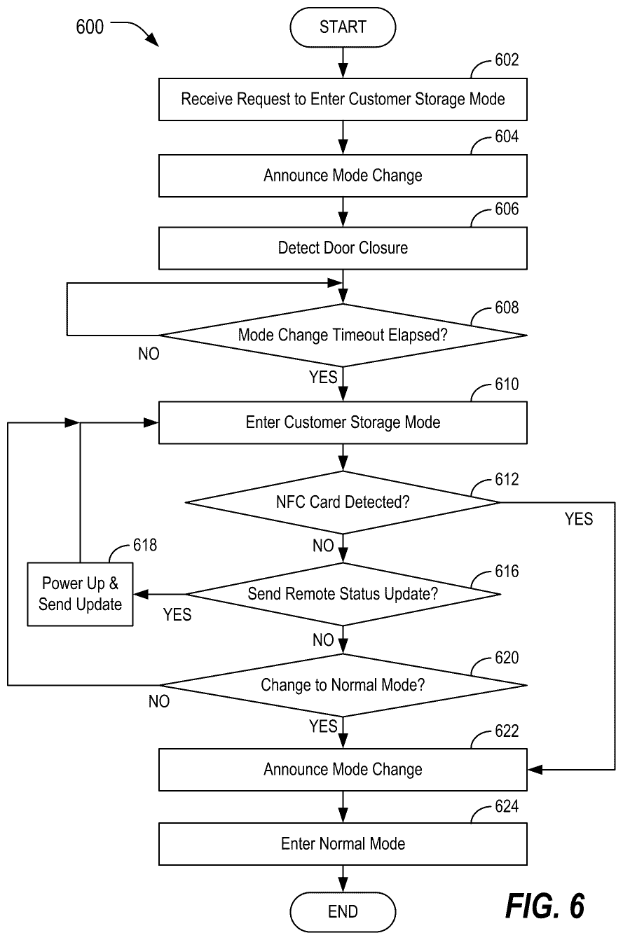

FIG. 6 illustrates an example process 600 for transitioning the vehicle 100 by an end customer between the storage mode 308 and the normal mode 302. The operations 602-624 of the process 600 are the same as operations 502-524 of the process 500 (respectively), except that detection of an NFC credential at operation 612 transitions to operation 622 to return to the normal mode 302. Thus, operation 514 is omitted in the process 600. These difference account for the customer-selected nature of the customer storage mode 308, in particular that the vehicle 100 may return to the normal mode 302 once the user returns.

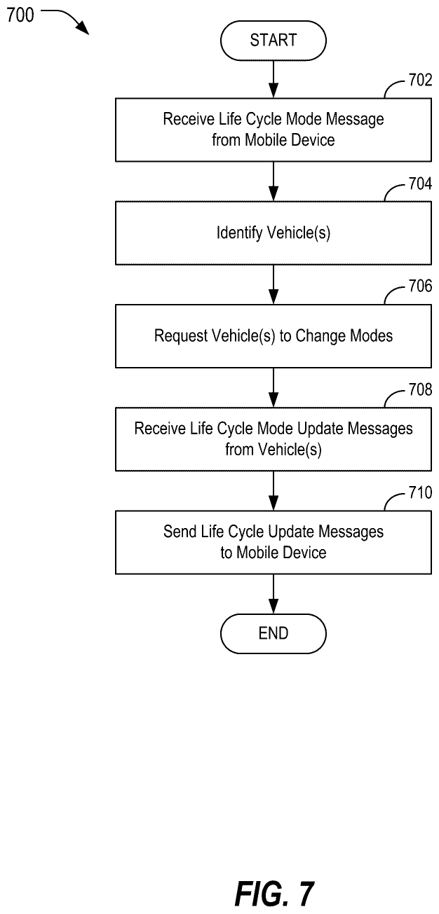

FIG. 7 illustrates an example process 700 for the remote configuration of the life cycle power management mode 300 of one or more vehicles 100. The process 700 may be useful, for example, for a fleet manager or other user desiring to configure the key-off power usage of vehicles 100. While the processes 500 and 600 are performed by vehicles 100, the process 700 is performed by the life cycle service 208 of the cloud server 210.

At operation 702, the life cycle service 208 receives a life cycle mode message 214 from the mobile device 204. In an example, the life cycle service 208 may receive the life cycle mode message 214 from the mobile device 204 responsive to user input to the user interface 206 presented to the user via the mobile device 204. The life cycle mode message 214 may include information indicating which mode of the life cycle power management modes 300 to place the vehicle 100 (or vehicles 100) into. In some cases, the life cycle mode message 214 may include additional identifying information, such as an identifier of the mobile device 204 making the request, an identifier of an account of a user of the mobile device 204 making the request (e.g., phone number, e-mail address, etc.), and/or an identifier of the vehicle 100 or vehicles 100 whose life cycle power management mode 300 is to be updated (e.g., VIN or some other unique vehicle 100 identifier).

At operation 704, the life cycle service 208 identifies the vehicle(s) 100 corresponding to the mobile device 204. As an example, the life cycle service 208 may identify the vehicle 100 based on identifying information regarding the vehicle 100 included in the life cycle mode message 214. As another example, the life cycle service 208 may identify the vehicle 100 based on an existing login session of the mobile device 204 with the life cycle service 208. In another example, the life cycle service 208 may access the database 212 to identify the VINs and/or contact information for the vehicles 100 associated with a fleet that the mobile device 204 is configured to manage.

At operation 706, the life cycle service 208 sends a request to the vehicle(s) 100 to request the vehicle(s) 100 to transition the life cycle power management mode 300 of the vehicle(s) 100. The request to the vehicle 100 may accordingly be configured to cause the vehicle 100 to transition to the extended park mode setting selected by the user via the user interface 206 of the mobile device 204.

At operation 708, the life cycle service 208 receives a life cycle update message 216 from the vehicle 100. The life cycle update messages 216 may include information such as the current life cycle power management mode 300 of the vehicle 100. These life cycle update messages 216 may accordingly allow the life cycle service 208 to track which vehicles 100 are in which mode, and which vehicles 100 are not. This information may be maintained, for example, to allow the life cycle service 208 to only send messages to the vehicle 100 that are appropriate for vehicles 100 that are in extended park mode (e.g., only a limited set of messages such as door unlock, exit extended park mode, but not download or install a software update). As an example, based on the current state information, at operation 706 the life cycle service 208 may only send the requests to the vehicle 100 to change the life cycle power management mode 300 setting when the life cycle service 208 determines that the user has selected a change to the current life cycle power management mode 300 setting for the vehicle 100.

At operation 710, the life cycle service 208 sends life cycle update messages 216 to the mobile device 204. For example, responsive to the request received at operation 702, the life cycle service 208 provides an update to the mobile device 204 indicating the updated life cycle power management modes 300 of the vehicle(s) 100. This may allow the user of the mobile device 204 to confirm that the updates were made, and/or to identify any vehicles 100 that did not update to the requested life cycle power management mode 300. After operation 710, the process 700 ends.

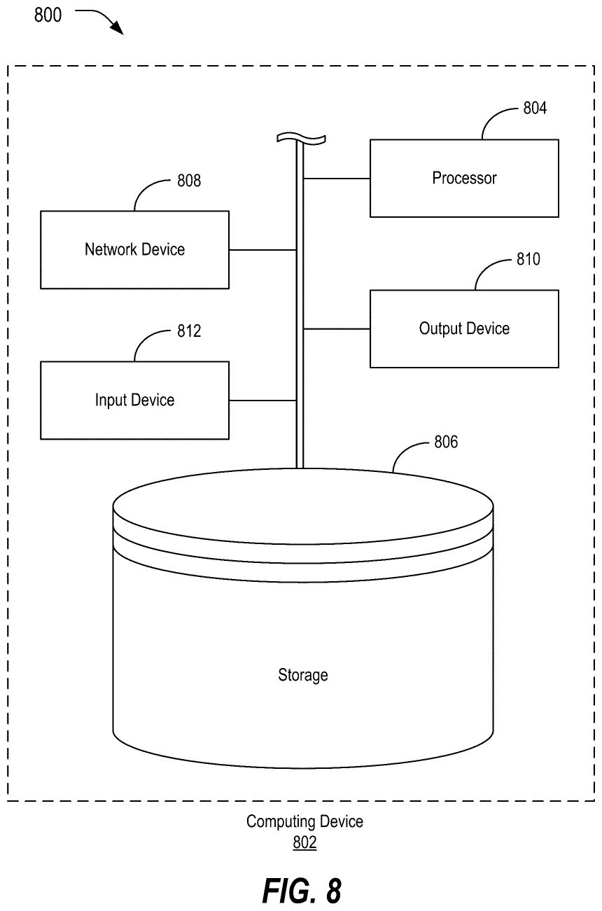

FIG. 8 illustrates an example computing device 802 for implementing a plurality of life cycle power management modes 300 of vehicles 100. Referring to FIG. 8, and with reference to FIGS. 1-7, the vehicles 100, powered systems 104, controllers 114, access control systems 122, communications network 202, mobile devices 204, cloud server 210, and database 212 may be examples of such computing devices 802. Computing devices 802 generally include computer-executable instructions, where the instructions may be executable by one or more computing devices 802. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

As shown, the computing device 802 may include a processor 804 that is operatively connected to a storage 806, a network device 808, an output device 810, and an input device 812. It should be noted that this is merely an example, and computing devices 802 with more, fewer, or different components may be used.

The processor 804 may include one or more integrated circuits that implement the functionality of a central processing unit (CPU) and/or graphics processing unit (GPU). In some examples, the processors 804 are a system on a chip (SoC) that integrates the functionality of the CPU and GPU. The SoC may optionally include other components such as, for example, the storage 806 and the network device 808 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 804 executes stored program instructions that are retrieved from the storage 806. The stored program instructions, accordingly, include software that controls the operation of the processors 804 to perform the operations described herein. The storage 806 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 810. The output device 810 may include a graphical or visual display device, such as an electronic display screen, projector, printer, or any other suitable device that reproduces a graphical display. As another example, the output device 810 may include an audio device, such as a loudspeaker or headphone. As yet a further example, the output device 810 may include a tactile device, such as a mechanically raiseable device that may, in an example, be configured to display braille or another physical output that may be touched to provide information to a user.

The input device 812 may include any of various devices that enable the computing device 802 to receive control input from users. Examples of suitable input devices 812 that receive human interface inputs may include keyboards, mice, trackballs, touchscreens, microphones, graphics tablets, and the like.

The network devices 808 may each include any of various devices that enable the described components to send and/or receive data from external devices over networks. Examples of suitable network devices 808 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for implementing a plurality of life cycle power management modes for a vehicle, comprising:
operating a vehicle in a transport mode wherein controllers of the vehicle are configured to reduce their respective key-off loads on a battery of the vehicle while the vehicle is being transported, including that doors of the vehicle are unlocked and access control systems of the vehicle are unpowered;
responsive to receipt of a first request for moving the vehicle to a transport temporary normal mode, transitioning the vehicle from the transport mode to the transport temporary normal mode, the transport temporary normal mode being another of the life cycle power management modes, wherein, in the transport temporary normal mode, the controllers of the vehicle are configured to operate in a full power state; and
returning the vehicle from the transport temporary normal mode to the transport mode after a predefined timeout period elapses after detecting a key-off state and/or closure of the doors of the vehicle.

2. The method of claim 1, further comprising transitioning the vehicle from a factory mode to the transport mode responsive to the vehicle detecting that the vehicle has left a geofenced area of a factory, the factory mode being another of the plurality of the life cycle power management modes.

3. The method of claim 1, wherein the transport mode comprises:
a shallow sleep substate in which network hardware providing vehicle connectivity over a communications network is powered to receive over-the-air updates for a predefined period of time; and
a deep sleep substate following the shallow sleep substate, in which the network hardware is unpowered to further reduce power consumption after the predefined period elapses.

4. The method of claim 1, further comprising:
responsive to receipt of a second request, the second request indicating for the vehicle to transition to a storage mode, transitioning the vehicle from the transport mode to the storage mode, the storage mode being another of the life cycle power management modes, wherein in the storage mode, the doors are locked and a near field communication (NFC) access control system of the vehicle is powered to allow controlled access to the vehicle.

5. The method of claim 4, wherein the second request includes the vehicle having entered a geofenced area of a dealership.

6. The method of claim 5, further comprising:
transitioning the vehicle from the transport mode to a normal mode responsive to detecting at least one of: the vehicle having driven a predefined distance threshold, receipt of an indication that a warranty of the vehicle is activated, and/or that the vehicle has remained outside the geofenced area of the dealership for at least a predefined time period.

7. The method of claim 4, further comprising:
responsive to detecting an NFC credential by the NFC access control system of the vehicle, transitioning the vehicle from the storage mode to a storage temporary normal mode, the storage temporary normal mode being another of the life cycle power management modes, wherein in the storage temporary normal mode the controllers of the vehicle are configured to operate in the full power state; and
returning the vehicle from the storage temporary normal mode to the storage mode after the predefined timeout period elapses after detecting the key-off state and/or closure of the doors of the vehicle.

8. The method of claim 4, further comprising:
receiving a life cycle mode message from a life cycle service of a cloud server, the life cycle mode message indicating one or more of the first request or the second request; and
responsive to performing the transitioning requested by the life cycle mode message, sending a life cycle update message to the life cycle service of the cloud server indicating that the transitioning was performed.

9. The method of claim 8, further comprising, while in the storage mode and/or in the transport mode, sending remote status updates to the life cycle service indicating one or more of a current location of the vehicle and/or a state of charge of the battery of the vehicle.

10. The method of claim 1, further comprising announcing the transitioning between life cycle power management modes using a human-machine interface (HMI) of the vehicle.

11. A vehicle implementing a plurality of life cycle power management modes, comprising:
a battery; and
a plurality of controllers configured to:
operate a vehicle in a transport mode wherein controllers of the vehicle are configured to reduce their respective key-off loads on a battery of the vehicle while the vehicle is being transported, including that doors of the vehicle are unlocked and access control systems of the vehicle are unpowered;
responsive to receipt of a first request for moving the vehicle to a transport temporary normal mode, transition the vehicle from the transport mode to the transport temporary normal mode, the transport temporary normal mode being another of the life cycle power management modes, wherein, in the transport temporary normal mode, the controllers of the vehicle are configured to operate in a full power state; and
return the vehicle from the transport temporary normal mode to the transport mode after a predefined timeout period elapses after detecting a key-off state and/or closure of the doors of the vehicle.

12. The vehicle of claim 11, wherein the plurality of controllers are further configured to transition the vehicle from a factory mode to the transport mode responsive to the vehicle detecting that the vehicle has left a geofenced area of a factory, the factory mode being another of the plurality of the life cycle power management modes.

13. The vehicle of claim 11, wherein the transport mode comprises:
a shallow sleep substate in which network hardware providing vehicle connectivity over a communications network is powered to receive over-the-air updates for a predefined period of time; and
a deep sleep substate following the shallow sleep substate, in which the network hardware is unpowered to further reduce power consumption after the predefined period elapses.

14. The vehicle of claim 11, wherein the plurality of controllers are further configured to:
responsive to receipt of a second request, the second request indicating for the vehicle to transition to a storage mode, transition the vehicle from the transport mode to the storage mode, the storage mode being another of the life cycle power management modes, wherein in the storage mode, the doors are locked and a NFC access control system of the vehicle is powered to allow controlled access to the vehicle.

15. The vehicle of claim 14, wherein the second request includes the vehicle having entered a geofenced area of a dealership.

16. The vehicle of claim 15, wherein the plurality of controllers are further configured to:
transition the vehicle from the transport mode to a normal mode responsive to detecting at least one of: the vehicle having driven a predefined distance threshold, receipt of an indication that a warranty of the vehicle is activated, and/or that the vehicle has remained outside the geofenced area of the dealership for at least a predefined time period.

17. The vehicle of claim 14, wherein the plurality of controllers are further configured to:
responsive to detecting an NFC credential by the NFC access control system of the vehicle, transition the vehicle from the storage mode to a storage temporary normal mode, the storage temporary normal mode being another of the life cycle power management modes, wherein in the storage temporary normal mode the plurality of controllers are configured to operate in the full power state; and
return the vehicle from the storage temporary normal mode to the storage mode after the predefined timeout period elapses after detecting the key-off state and/or closure of the doors of the vehicle.

18. The vehicle of claim 14, wherein the plurality of controllers are further configured to:
receive a life cycle mode message from a life cycle service of a cloud server, the life cycle mode message indicating one or more of the first request or the second request; and
responsive to performing the transition requested by the life cycle mode message, send a life cycle update message to the life cycle service of the cloud server indicating that the transition was performed.

19. The vehicle of claim 18, wherein the plurality of controllers are further configured to, while in the storage mode and/or in the transport mode, send remote status updates to the life cycle service indicating one or more of a current location of the vehicle and/or a state of charge of the battery of the vehicle.

20. The vehicle of claim 11, wherein the plurality of controllers are further configured to announce the transition between life cycle power management modes using a HMI of the vehicle.
